(19) United States
(12) Patent Application Publication
(10) Pub. No.: US 2018/0094123 A1
(43) Pub. Date: Apr. 5, 2018

(54) Biological Composite Material

(71) Applicant: Hans-Peter Meyerhoff, Bensheim (DE)

(72) Inventor: Hans-Peter Meyerhoff, Bensheim (DE)

(21) Appl. No.: 15/542,448

(22) PCT Filed: Jan. 11, 2016
(86) PCT No.: PCT/EP2016/050403

§ 371 Date: Jul. 10, 2017

(30) Foreign Application Priority Data
Jan. 11, 2015 (EP) 15150716.7
Oct. 7, 2015 (EP) 15188813.8

(51) Int. Cl. C08K 11/00; C09C 1/40; C08K 3/36; C08L 23/10; C08L 23/04

(52) U.S. Cl. CPC C08K 11/005; C09C 1/405; C08K 2201/005; C08L 23/10; C08L 23/04; C08K 3/36

(57) ABSTRACT

A plastics compound includes a biological component, wherein at least (a) at least one biomineral filler and (b) at least one polymer are processed to give a compound. This is done using a renewable biomineral filler having a high proportion of silicon dioxide.

### FIELD OF THE INVENTION

The invention relates to plastics comprising biological fillers.

Biomaterials are understood to mean plastics based fully or in relevant proportions on renewable raw materials. In view of rising costs for oil, the use of biomaterials is of interest not just for reasons of sustainability but also on the basis of economic considerations.

There have been many recent examples of biomaterials, usually oil-based plastics with a particular proportion of biologically produced fillers and/or fibers.

A relatively new field is the replacement of the plastics with plastics made from renewable raw materials or from waste products, for example polypropylene or polyethylene from sugarcane, fats or oils.

Very frequently, biological fillers based on wood are used.

A common problem with such biomaterials is their often inadequate thermal stability.

Moreover, the effect of introduction of a usually hydrophilic material into a hydrophobic environment, such as plastics, is that the biomaterials have a tendency to absorb water. This is usually associated with a change in volume, for example by 1% to 6%. This makes these materials unsuitable for outdoor applications or for moist environments.

The hydrophobic environment is also problematic in the case of biological fillers having a high proportion of inorganic components, especially when a plastic with a high filler level is to be produced.

The UV resistance of such plastics is another problem.

There is therefore a need for biomaterials which overcome the disadvantages of the known biomaterials and especially have low absorption of water and swelling, and as far as possible have high impact resistance and good chemical resistance.

Existing fillers are also frequently obtained from non-renewable sources or come from fossil sources such as talc and chalk, by way of example.

Object

It is an object of the invention to provide a plastics composition comprising a biological filler which avoids the disadvantages of the prior art. The plastics produced may also be plastics with a high filler level.

Achievement of Object

This object is achieved by the inventions having the features of the independent claims. Advantageous developments of the inventions are identified in the dependent claims. The wording of all the claims is hereby incorporated by reference into the content of this description. The inventions also encompass all viable combinations, and especially all the mentioned combinations, of independent and/or dependent claims.

The object is achieved by a plastics compound having a biological component, comprising at least (a) at least one biomineral filler and (b) at least one polymer.

The biological filler may come from many different global sources. Biomineral fillers are biological fillers having a high proportion of inorganic constituents, especially from renewable raw materials. Particular preference is given to biological fillers having an ash content of more than 5 percent by mass, preferably more than 10 percent by mass (ash content at 815° C. to DIN 51719). All specifications of standards in the measurement of properties, for example DIN 51719, relate to the most recent version of the respective standard at the filing date.

Particular preference is given to plant sources having a high proportion of silicon dioxide, more preferably having a proportion of at least 3% by weight, preferably at least 5% by weight (based on the biological filler, measured by x-ray fluorescence analysis), preferably at least 10% by weight, more preferably more than 15% by weight or more than 25% by weight. Preference is therefore given to sources having a proportion of 5% to 98% by weight, preferably 10% to 98% by weight, more preferably 15% to 98% by weight or 20% to 98% by weight.

A high proportion of silicon dioxide and an associated relatively low proportion of bioorganic materials ensure that the water absorption of the compositions of the invention is low. Preference is given to a water absorption of 0.3% by mass, preferably 0.2 (measured according to ISO 62).

It may be necessary to dry the biomineral filler prior to use.

Preference is given to a biological filler or biomineral filler which is obtained from an infinitely renewable raw material.

The biological filler is preferably obtained from rice hulls, rice husks, sisal, hemp, cotton, pinewood, kenaf, bamboo, flax and/or sugarcane.

The biomineral filler is preferably the ash obtained from rice hulls, rice husks, sisal, hemp, cotton, pinewood, kenaf, bamboo, flax and/or sugarcane, more preferably the ash from rice hulls and/or rice husks, most preferably the ash from rice hulls (rice hull ash, RHA).

Rice hull ash has the particular advantage here of being available in large volumes as a waste product in rice production. Moreover, as a result of the structure of rice, the ash is already in the form of very fine grains. It can also be obtained in various quality levels.

Preference is given to a silicon dioxide content in the filler of at least 20% by weight, preferably at least 40% by weight, more preferably at least 60% by weight. Preference is further given to a proportion of 40% to 98% by weight (determined by x-ray fluorescence spectroscopy), preferably of 60% by weight to 98% by weight, more preferably of 80% by weight to 98% by weight. The proportion may also be in the range from 75% by weight to 98% by weight, preferably in the range from 85% by weight to 98% by weight.

Particular preference is given to a biomineral filler material having an SiO₂ content of at least 80% by weight, preferably at least 90% by weight. The content may be 80% by weight to 99% by weight, preferably 80% by weight to 98% by weight) more preferably 90% by weight to 99% by weight.

Depending especially on the carbon content, the filler may be black, anthracite, light gray to dark gray or white in color.

Preferably more than 50% by weight of the silicon dioxide is amorphous silicon dioxide, especially more than 80% by weight, or more than 90% by weight.

In a preferred embodiment of the invention, the carbon content in the biomineral filler is 0% to 10% by weight, preferably 0% to 6% by weight, more preferably 0% to 3% by weight.

Rice hull ash in particular has a high proportion of amorphous silicon dioxide. Depending on the production, the proportion of crystalline SiO₂, especially of cristobalite, can be minimized, especially to below 20% by weight, preferably below 10% by weight, most preferably to below 5% by weight.

Many of the aforementioned components occur as a by-product or waste product. They are therefore frequently available at economically viable cost in infinite amounts.

There is also no competition with food production through the use of rice hulls. At the same time, the product is globally available in very large volumes. The ash is used in particular as an additive for concretes or steel. It is also possible to use the heat that arises in the production for generation of energy.

The biological filler material also comprises up to 30% by weight of further constituents, preferably up to 20% by weight. Preference is given to further oxides of Fe, Al, Zr, Na, K, Mg, Mn, Ca each with proportions of 0% to 10% by weight, preferably 0% to 5% by weight, more preferably with proportions of 0% to 3% by weight.

In one embodiment of the invention, the further constituents include an oxide selected from the group of Fe, Al, Zr, Na, K, Mg, Mn, Ca each with proportions of 0.1% to 10% by weight, preferably 0.1% to 5% by weight, more preferably with proportions of 0.1% to 3% by weight. The oxide is preferably selected from the group of Fe and Al. This does not rule out the occurrence of other oxides in similar or smaller proportions, although the figures together with the content of the other constituents always add up to 100%.

In one embodiment of the invention, the biological filler material comprises at least the following constituents:

| | % by wt. |
|---|---|
| SiO₂ | 80-99 |
| Fe₂O₃ | 0-3, preferably 0-1.5 |
| CaO | 0-3 |
| MgO | 0-3 |
| K₂O | 0-5 |
| Na₂O | 0-5 |
| ZrO₂ | 0-5 |

This material is clearly a biomineral filler. In addition, it is always also possible for further constituents to be present, such as 0% to 10% by weight of carbon, preferably 0% to 5% by weight, more preferably 0% to 1% by weight. Furthermore, it is also possible for impurities and a small amount of moisture to be present.

In a further embodiment of the invention, the biological filler material comprises at least the following constituents:

| | % by wt. |
|---|---|
| SiO₂ | 80-99 |
| Fe₂O₃ | 0.1-1.5 |
| CaO | 0.1-1 |
| MgO | 0.1-2 |
| K₂O | 0.1-5 |
| Na₂O | 0.1-5 |
| ZrO₂ | 0-5 |

In addition, it is always also possible for further constituents to be present, such as 0% to 10% by weight of carbon, preferably 0% to 5% by weight, more preferably 0% to 1% by weight, most preferably 0.1% to 1% by weight. Furthermore, it is also possible for impurities and a small amount of moisture to be present.

The proportion of VOCs (volatile organic compounds) is preferably below 1% by weight (105° C., 20 hours; starting weight 8 g).

The biomineral filler material preferably has a thermal stability of at least 1000° C.

Fillers having such a high SiO₂ content do not just have low water absorption capacity; they also allow higher temperatures in processing. It is therefore possible to incorporate fillers of this kind into many thermoplastics. Thus, processing temperatures of more than 150° C. or more than 450° C., especially well above 450° C., are also possible. This allows, for example, incorporation into polyamides such as nylon-6,6.

In a non-preferred embodiment, the biomineral filler has a median particle size of up to 500 μm, preferably between 5 μm and 400 μm (measured by light scattering). This figure is based on the particle size in the finished composition.

In a preferred embodiment, at least 90% of the particles of the filler on addition to the composition have a particle size of below 400 μm (90% value measured by laser diffraction), especially preferably with additionally a 50% value below 300 μm.

In a further embodiment, the biological filler has a 95% value below 600 μm, and preferably additionally a 50% value below 300 μm.

In a further embodiment, all particles analyzed by laser diffraction in the filler are smaller than 1.5 mm, preferably additionally with a 90% value below 400 μm and a 50% value below 300 μm.

The biomineral filler preferably has a specific density between 0.08 and 3.2 g/cm³, preferably between 1.5 and 2.5 g/cm³.

The biological filler material preferably has a density of up to 2.5 g/cm³, preferably up to 2.4 g/cm³, preferably of up to 2.3 g/cm³. Preference is given to a density of at least 1.8 g/cm³. The density is therefore preferably within a range from 1.8 g/cm³ to 2.5 g/cm³, especially 1.8 g/cm³ to 2.3 g/cm³, most preferably from 1.8 g/cm³ to 2.2 g/cm³. Preference is given to a density of 2.0 to 2.4 g/cm³. The density is based on the density of the material (specific density), not the bulk density.

The particles of the biological filler are preferably slightly porous. It preferably has a specific surface area of 15 to 30 m²/g (BET measurement with nitrogen).

Rice hull ash in particular has a low specific density of up to 2.3 g/cm³, especially of 1.8 to 2.2 g/cm³. The density can be influenced correspondingly by the production process. Together with the high content of silicon dioxide, it is possible to produce similar composites with such high filler levels that have a lower density compared to standard fossil filler materials such as talcum or chalk, mica, wollastonite, etc.

In one embodiment of the invention, the biological filler material is in powder form, preferably having a bulk density of 200 to 800 kg/m³.

It may be advantageous that the filler has a particular size distribution. This can be achieved by sieving operations and/or grinding operations.

Depending on the application, it may be advantageous to use biomineral filler having a particular size distribution. For example, it is possible to remove all particles having a size exceeding 100 μm, preferably exceeding 80 μm, especially exceeding 60 μm, on the filler in a preceding step by means of a sieving step. This sieved biomineral filler is of particularly good suitability.

Preferably, suspensions of the biological filler material in water have a pH of 4-7, and in another embodiment of 6-8 (in each case measured as 5% by weight at room temperature).

In a preferred embodiment, at least 50% of the filler particles are spherical based on number, preferably at least 60%, especially at least 80% (determined by microscopy). This means that these particles can be described approximately by a sphere or spheroid, where the aspect ratio of the axes is not greater than 3:1, especially not greater than 1.5:1.

The proportion of the biomineral filler is preferably at least 15% by weight based on the compound, more preferably at least 20% by weight, more preferably from 15% by weight to 90% by weight, especially 15% by weight to 80% by weight, particular preference being given to a proportion of 10% by weight to 40% by weight.

The biomineral filler also increases the content of renewable raw materials in the composite material. As a result, it is possible to economize on the usually oil-based plastics.

It is also possible to use mixtures of two or more biological fillers. For instance, it is possible to combine fillers based on ash with other biological fillers. Preferably, at least one biological filler here is a filler based on ash. The at least one further filler is preferably selected from rice hulls, rice husks, wood, sisal, hemp, cotton, pinewood, kenaf, bamboo, flax and/or sugarcane. For example, it is possible to combine ash from rice hulls or rice husks with other biological fillers. The further biological filler may also comprise fibers, for example wood fibers, sisal fibers, hemp fibers, jute fibers, cotton fibers.

In a preferred embodiment of the invention, the biological filler comprises biological fillers based on ash at least to an extent of 30% by weight, preferably at least 50% by weight, more preferably at least 60% by weight, based on all the biological fillers used.

The at least one polymer is preferably a thermoplastic or crosslinkable polymer, a thermoset or thermoplastic elastomer.

A thermoplastic polymer or thermoplastic elastomer (b) is understood to mean any thermoplastically formable polymer, which may be virgin polymer or recycled/ground material composed of used thermoplastic polymers. Preference is given to thermoplastics having a viscosity corresponding to a melt flow index (MFI, 230° C./2.16 kg) of polypropylene (PP) of at least 20 g/10 min. Preference is given to those whose viscosity corresponds to an MFI of PP of 20 to 300 g/10 min, more preferably 50 g/10 min to 200 g/10 min.

It is possible to use, for example, polyolefins such as polyethylene, polypropylene, polybutylene, polyisobutylene and poly-4-methyl-1-pentene, polyolefin copolymers such as Luflexen® (Basell), Nordel® (Dow) and Engage® (DuPont), cycloolefin copolymers such as Topas® (Celanese), polytetrafluoroethylene (PTFE), ethylene/tetrafluoro-ethylene copolymers (ETFE), polyvinylidene difluoride (PVDF), polyvinyl chloride (PVC), polyvinylidene chloride, polyvinyl alcohols, polyvinyl esters such as polyvinyl acetate, vinyl ester copolymers such as ethylene/vinyl acetate copolymers (EVA), polyvinyl alkanals such as polyvinyl acetal and polyvinyl butyral (PVB), polyvinyl ketals, polyamides such as nylon-6, nylon-12, nylon-6,6, N 6/6,6 triple 6, or mixtures of N 6,6 recyclate with N 6 or other polyamide components, nylon-6,10, polyimides, polystyrenes, polycarbonate, polycarbonate copolymers and physical blends of polycarbonates with acrylic-butadiene-styrene copolymers, acrylonitrile-styrene-acrylic ester copolymers, polymethylmethacrylates, polybutylacrylates, polybutylmethacrylates, polybutylene terephthalates and polyethylene terephthalates, polyesters such as polyethylene terephthalate (PET), polybutylene terephthalate (PBT) and polyethylene naphthalate (PEN), copolymers, transesterification products and physical mixtures (blends) of the aforementioned polyalkylene terephthalates, poly(meth)acrylates, polyacrylamides, polyacrylonitrile, poly(meth)acrylate/polyvinylidene difluoride blends, polyurethanes, polystyrene, styrene copolymers such as styrene/butadiene copolymers, styrene/acrylonitrile copolymers (SAN), acrylic ester-styrene acrylonitrile (ASA), alpha-methyl-styrene-acrylonitrile copolymer (AMSAN), styrene-butadiene-styrene (SBS), styrene/ethyl methacrylate copolymers, styrene/butadiene/ethyl acrylate copolymers, styrene/acrylonitrile/methacrylate copolymers, acrylonitrile/butadiene/styrene copolymers (ABS) and methacrylate/butadiene/styrene copolymers (MBS), polyethers such as polyphenylene oxide, polyether ketones, vinyl ester copolymers, polysulfones, for example polyethylene terephthalate or polybutylene terephthalates, polyether sulfones, polyether imides, polyphenylene oxide, polyphenylene sulfide, polyglycols such as polyoxymethylene (POM), polyaryls such as polyphenylene, polyarylenevinylenes, silicones, low-density polyethylene (LDPE), high-density polyethylene (HDPE), ionomers, thermoplastic and thermoset polyurethanes and mixtures thereof.

Polyimides used may, for example, be nylon-6, nylon-6,6, triple 6/6,6 and N 6,6 with proportions of N 6, mixtures and corresponding copolymers.

The at least one thermoplastic may also be part of a blend, for example in blends composed of styrene polymers such as SAN with polymethacrylonitrile (PMI) or chlorinated polyethylene, or polyvinyl chloride with methyl acrylate-butadiene-styrene copolymer (MBS), ASA and/or ABS. What is important here is that the mixture obtained is still a thermoplastic.

Preferably, at least one thermoplastic is a polyolefin, more preferably polypropylene (PP) or polyethylene (PE) and copolymers or mixed polymers thereof, for instance EPDM (ethylene-propylene-diene)-modified PP, ethylene-vinyl acetate copolymer (EVA), rubber mixtures or else in the reactor PP-EPDM prepared types; for example, by the cascade principle, each stage gives, for example, +5% EPDM.

It is also possible to use a thermoset. These are preferably polymers comprising the aforementioned polymers which have additionally been crosslinked with one another. This can be accomplished by appropriate selection of the monomers and/or addition of at least one crosslinker. Examples are thermoset synthetic resins such as diallyl phthalate resins (PDAP), epoxy resins (EP), amino resins (e.g. urea resins, melamine resins, dicyandiamide resins), phenolic resins (e.g. phenol-formaldehyde resin), furfuryl alcohol-formaldehyde resins (FF), unsaturated polyester resins (UP), polyurethane resins (PU), reactively injection-molded polyurethane resins (RIM-PU), furan resins, vinyl ester resins (VE, VU), polyester-melamine resins, mixtures of diallyl phthalate (PDAP) resins or diallyl isophthalate (PDAIP) resins, silicone resins.

Likewise possible are plastics based on polylactate.

The polymers used have to be processible at the temperatures employed.

The polyolefin may be crystalline or amorphous polyolefin.

In a preferred development of the invention, at least 50% by weight, 60% by weight, 70% by weight, 90% by weight, preferably 100% by weight, of the polymer and/or elastomer used is at least one polyolefin.

In a further embodiment of the invention, the polyolefin is at least partly likewise obtained from renewable sources, for example sugarcane, fats or oils. Together with the biological filler, it is thus possible to obtain a composite material which has been produced from renewable sources to an extent of more than 30% by weight, preferably more than 50% by weight, more preferably more than 65% by weight. Such sources are, for example, plants such as sugarcane, but may also be fats or oils which also occur as waste products.

In one embodiment of the invention, the thermoplastic (b) has a mean molecular weight M_{W} in the range from 10 000 to 200 000 (measured by ultracentrifuge), preferably from 100 000 to 200 000.

Polyethylene and polypropylene each also include copolymers of, respectively, ethylene and propylene with one or more α-olefin or styrene. Thus, in the context of the present invention, polyethylene also includes copolymers containing, in copolymerized form, as well as ethylene as main monomer (at least 50% by weight), one or more comonomers preferably selected from styrene, vinyl acetate or α-olefins, for example propylene, 1-butene, 1-hexene, 4-methyl-1-pentene, 1-octene, 1-decene, 1-dodecene, n-α-C₂₂H₄₄, n-α-C₂₄H₄₈ and n-α-C₂₀H₄₀. In the context of the present invention, polypropylene also includes copolymers containing, in copolymerized form, as well as propylene as main monomer (at least 50% by weight), one or more comonomers preferably selected from styrene, ethylene, 1-butene, 1-hexene, 4-methyl-1-pentene, 1-octene, 1-decene, 1-dodecene, n-α-C₂₂H₄₄, n-α-C₂₄H₄₈ and n-α-C₂₀H₄₀.

The compound preferably comprises at least 5% by weight of component (a), preferably from 5% by weight to 80% by weight.

Preferably, the glass transition temperature (T_{G}, determinable as the turning point in the DSC diagram) for the at least one thermoplastic is below 150° C.; it is preferably between 60° C. and 120° C.

In the compounding, it is also possible to process at least one compatibility-promoting additive (c).

Compatibilizers or couplers (coupling agents) of this kind are preferably compounds based on maleic anhydride, maleated polyethylenes or maleated polypropylenes, or copolymers of ethylene or propylene and acrylic acid, methacrylic acid or trimellitic acid. The content of such couplers is preferably between 0% and 8% by weight.

Compatibilizers used may also be saturated or unsaturated organosilanes. Functional organosiloxanes can increase compatibility. Functional organosiloxanes, for example organylorganyloxysilanes, in this context are those silanes which bear at least one organic radical which is bonded to the silicon atom via a carbon atom and may in turn contain a functional group.

The easier dispersion may be attributable to hydrophobization of the surface of the biological filler brought about by the silane. Preference is therefore given to silanes bearing at least one hydrolyzable radical and at least one nonhydrolyzable radical.

If silanes having at least one crosslinkable group are used, the silanes may contain radicals having at least one unsaturated carbon bond, for example vinyl, acrylate or methacrylate groups. It is also possible for epoxy groups to be present.

It may be necessary additionally to add crosslinkers if substances having crosslinkable groups are being added.

It may also be necessary to add at least one solvent. The solvent may also be water, for example in order to hydrolyze added silanes.

In one embodiment of the present invention, the composition further comprises at least one additive (d). Examples of additives are stabilizers, especially light and UV stabilizers, for example sterically hindered amines (HALS), 2,2,6,6-tetramethylmorpholine N-oxides or 2,2,6,6-tetramethylpiperidine N-oxides (TEMPO) and other N-oxide derivatives such as NOR.

Further examples of suitable additives are UV absorbers, for example benzophenone or benzotriazoles.

Further examples of suitable additives are pigments which can likewise bring about stabilization against UV light, for example titanium dioxide (for example as white pigment), or suitable substitute white pigments, carbon black, iron oxide, other metal oxides and organic pigments, for example azo and phthalocyanine pigments.

Further examples of suitable additives are biocides, especially fungicides.

Further examples of suitable additives are acid scavengers, for example alkaline earth metal hydroxides or alkaline earth metal oxides or fatty acid salts of metals, especially metal stearates, more preferably zinc stearate and calcium stearate, and additionally chalks and hydrotalcites. It is possible here for some fatty acid salts of metals, especially zinc stearate and calcium stearate, also to function as lubricants in the course of processing.

Further examples of additives are antioxidants, for example based on phenols, such as alkylated phenols, bisphenols, bicyclic phenols or antioxidants based on benzofuranones, organic sulfides and/or diphenylamines.

Further examples of suitable additives are plasticizers, for example esters of dicarboxylic acids such as phthalates, organic phosphates, polyesters and polyglycol derivatives.

Further examples of suitable additives are impact modifiers (e.g.

polyamides, polybutylene terephthalates (PBTs)) and flame retardants. Examples of flame retardants, especially polycarbonate-based compositions, are halogen compounds, especially based on chlorine and bromine, and phosphorus-containing compounds. Preferably, the compositions contain phosphorus flame retardants from the groups of the mono- and oligomeric phosphoric and phosphoric esters, phosphonate amines and phosphazenes, but it is also possible to use mixtures of two or more components selected from one or various of these groups as flame retardant. It is also possible to use other phosphorus compounds that are not specifically mentioned here alone or in any desired combination with other flame retardants. Further flame retardants may be organic halogen compounds such as decabromobisphenyl ether, tetrabromobisphenol, inorganic halogen compounds such as ammonium bromide, nitrogen compounds such as melamine, melamine-formaldehyde resins, inorganic hydroxide compounds such as magnesium hydroxide, aluminum hydroxide, inorganic compounds such as antimony oxides, barium metaborate, hydroxoantimonate, zirconium oxide, zirconium hydroxide, molybdenum oxide, ammonium molybdate, zinc borate, ammonium borate, barium metaborate, talc, silicate, silicon oxide and tin oxide, and also siloxane compounds.

The flame retardants are often used in combination with so-called antidripping agents, which reduce the tendency of the material to produce burning drips in the event of fire. Examples here include compounds of the substance classes of the fluorinated polyolefins, the silicones, and aramid fibers. These may also be used in the compositions of the invention. Preference is given to using fluorinated polyolefins as antidripping agents.

Further examples of additives are inorganic fillers present in the form of particles and/or in laminar form, such as talc, chalk, kaolin, mica, wollastonite, silicas, magnesium carbonate, magnesium hydroxide, calcium carbonate, feldspar, barium sulfate, ferrite, iron oxide, metal powders, oxides, chromates, glass beads, hollow glass beads, pigments, silica, hollow spherical silicate fillers and/or sheet silicates. These preferably have a particle size between 2 and 500 μm (measured by light scattering).

The composition may also additionally contain crosslinkers which can lead to crosslinking of the thermoplastic or thermoset, for example on irradiation or heating.

If the molding compositions produced from the composition are to be foamed, it is possible to introduce chemical or physical blowing agents in liquid or solid form into the composition, for example sodium bicarbonate with citric acid or thermally labile carbamates. Preference is given to using endothermic foaming agents for this purpose. A further method of achieving foaming is the use of microspheres filled, for example, with gases or evaporable liquids. Suitable filling materials are particularly alkanes such as butane, pentane or hexane, but also the halogenated derivatives thereof, for example dichloromethane or perfluoropentane.

Alternatively, the foaming can also be achieved by setting appropriate process parameters (extrusion temperature, cooling rate of the solid profile), when the composition contains substances that become gaseous under the process conditions (e.g. water, hydrocarbons, etc.). The pores are preferably closed pores.

It is also possible to use mixtures of additives.

Examples of further reinforcers used as additives include glass fibers, especially short glass fibers, carbon fibers, graphite fibers, boron fibers, aramid fibers (p- or m-aramid fibers (e.g. Kevlar® or Nomex®, DuPont) or mixtures thereof) and basalt fibers, and it is also possible to use the reinforcing fibers mentioned in the form of long fibers or filaments having the customary ratios (length to diameter), including in the form of a mixture of various fibers. It is also possible to add thermoplastic fibers (for example composed of PP, PA, PET, PP-silicon fibers, etc.) or plant fibers, natural fibers or fibers of natural polymers. Examples of these are jute fibers, cotton fibers, sisal fibers and hemp fibers.

In one embodiment of the invention, the compound produced comprises long glass fibers having a length of at least 0.5 mm and a diameter of 3 to 25 μm.

In a further embodiment of the invention, the compound produced does not comprise any long glass fibers having a length of at least 0.5 mm and a diameter of 3 to 25 μm.

In the case of addition of an additive, especially of a filler, it should, however, be ensured that the viscosity of the compound in the course of processing does not fall below a value corresponding to an MFI of PP of not below 10 g/10 min.

The additives are preferably present at a content of 0% to 30% by weight, preference being given to a content of 0% to 20% by weight.

The compounds of the invention can be used to produce shaped bodies of any kind. These can be produced by injection molding, extrusion and blowmolding processes. A further form of processing is the production of shaped bodies by thermoforming from sheets or films produced beforehand.

The present invention further provides a masterbatch comprising at least components (a) and (b), with the difference that the masterbatch especially includes high proportions of biomineral filler. For instance, the masterbatch includes a proportion of biological filler of at least 30% by weight, preferably 30% to 90% by weight, preferably at least 50% by weight, especially 50% by weight to 90% by weight. Further constituents present may include 5% to 30% by weight of component (b) and 0% to 6% by weight of additives, preferably 0.5% by weight to 6% by weight. All of this is with the proviso that the proportions of the constituents add up to 100% by weight. The masterbatch is preferably produced by the process of the invention.

It is also possible to produce cable compounds, especially based on PVC. The inorganic biological component allows the proportion of nonbiological additions for insulation and/or flame retardancy to be reduced.

The object is also achieved by a process for producing a plastic with a biological component, wherein at least (a) at least one biomineral filler and (b) at least one polymer are processed to give a compound. The preferred embodiments correspond to those of the above-described plastics compound.

There follows a detailed description of individual process steps. The steps need not necessarily be conducted in the sequence specified, and the process to be outlined may also include further unspecified steps.

In a preferred embodiment of the invention, the compounding is effected in a mixing apparatus with high shear forces. More preferably, the mixing apparatus is an internal mixer or a single- or multipart/-shaft kneader. Especially preferred mixing apparatuses are kneader-like reactors, single- or multipart kneaders, single- or multi-shaft kneaders, mixers or mills. Very particular preference is given to single- or multi-shaft kneaders.

It has been found that standard single- or multishaft extruders do not achieve sufficient mixing of the components.

In a preferred embodiment, the mixing apparatus is a screw kneader, for instance a single-shaft kneader (e.g. co-kneader, single-screw kneader with mixing and shearing parts), twin-shaft kneader (e.g. ZSK- or ZE-type twin-screw extruder, Kombiplast extruder, MPC twin-screw kneading mixer, FCM two-stage mixer, KEX kneading screw extruder, shear roll extruder). Likewise suitable are kneaders with and without rams, trough kneaders and Banbury mixers. Preference is given to kneaders with rotational movement and translational (back-and-forth) movement.

In a very particularly preferred embodiment of the invention, the mixing apparatus is a co-kneader, for example from Buss Compounding Systems AG (Pratteln, Switzerland).

The kneading time is typically 0.5 to 24 hours.

The temperatures in the mixing apparatus are generally 20° C. to 350° C., depending on the polymer used, preferably 20° C. to 230° C.

The temperature can change over the length of the mixing apparatus, for example through one or more zones heated to different temperatures.

In a preferred embodiment of the invention, the compound is obtained in the form of pellets. The pelletized material can be obtained by correspondingly cutting the extrudate. In this way, for example, it is possible to obtain cylindrical pellets having a maximum extent of up to 20 mm, for example 1 mm to 5 mm. It is also possible to obtain disks or balls.

The production process may be followed by further customary steps in order to separate out pellets of the wrong size, or else drying steps.

It has been found that, surprisingly, the use of these mixing apparatuses having high shearing action, such as co-kneaders, enabled satisfactory compounding.

The invention also relates to the use of the biomineral filler material of the invention according to the embodiments described above, especially with a silicon dioxide content of at least 60% by weight, preferably at least 80% by weight, more preferably rice hull ash, most preferably white rice hull ash, as filler material in composite plastics, especially according to the composition of the invention or the masterbatch.

Examples of shaped bodies produced from the composite material according to the invention are films (as antiblocking agent), profiles, housing parts of any kind, for example for automobile interiors, such as instrument panels, domestic appliances such as juice presses, coffee machines, mixers; for office equipment such as monitors, printers, copiers; for plates, tubes, electrical installation ducts, windows, doors and profiles for the construction sector, internal fitting and outdoor applications, such as building interior or exterior parts; in the field of electrical engineering, such as for switches and plugs.

Examples of building interior parts are handrails, for example for indoor staircases, and panels. Examples of building exterior parts are roofs, facades, roof constructions, window frames, verandas, handrails for outdoor staircases, decking planks and cladding, for example for buildings or building parts. Examples of profile parts are technical profiles, connecting hinges, moldings for indoor applications, for example moldings having complex geometries, multifunctional profiles or packaging parts and decorative parts, furniture profiles and floor profiles. Composite materials of the invention are additionally suitable for packaging, for example for boxes and crates. The present invention further provides for the use of composite materials of the invention as or for production of furniture, for example of tables, chairs, especially garden furniture and benches, for example park benches, for production of profile parts and for production of hollow bodies, for example hollow chamber profiles for decking planks or window benches.

Moldings of the invention exhibit excellent weathering resistance, and additionally outstanding grip and very good mechanical properties and low water absorption, which leads to good weathering independence.

Test results for the filler and the shaped bodies produced are shown in the figures.

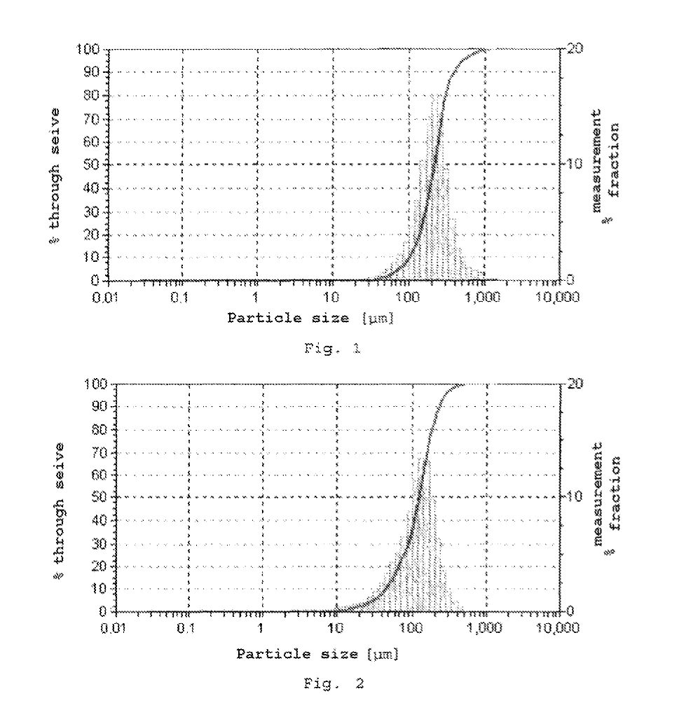

FIG. 1 particle size distribution of filler I (ACS 851);

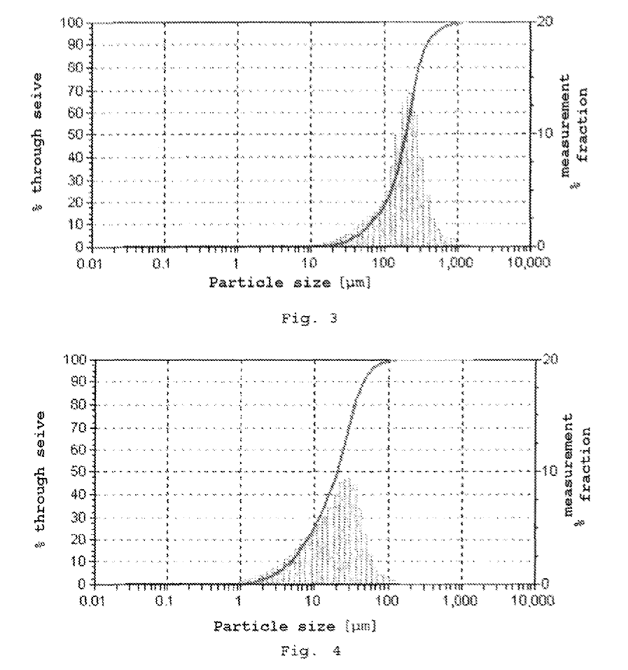

FIG. 2 particle size distribution of filler II (ACS 901);

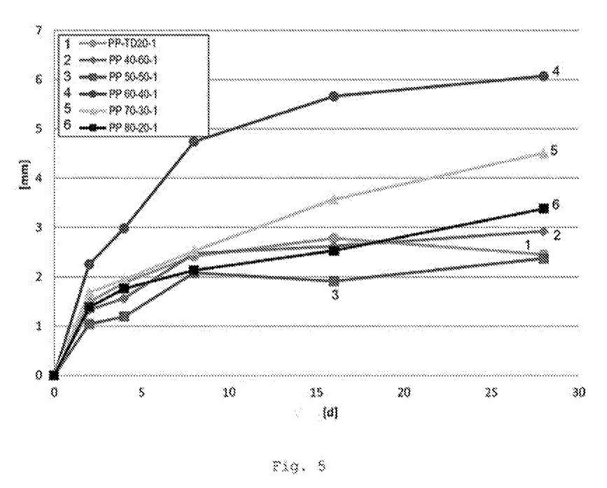

FIG. 3 particle size distribution of filler III (ACS 931);

FIG. 4 particle size distribution of filler IVa (ACS 952);

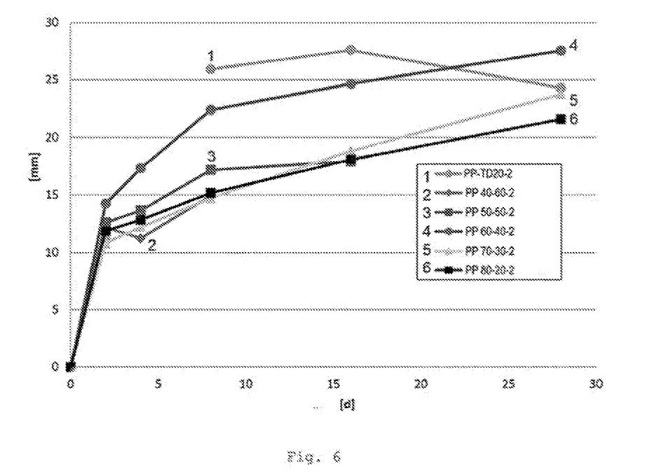

FIG. 5 tensile tests according to DIN EN ISO 527-2 at 1.8 N/mm²;

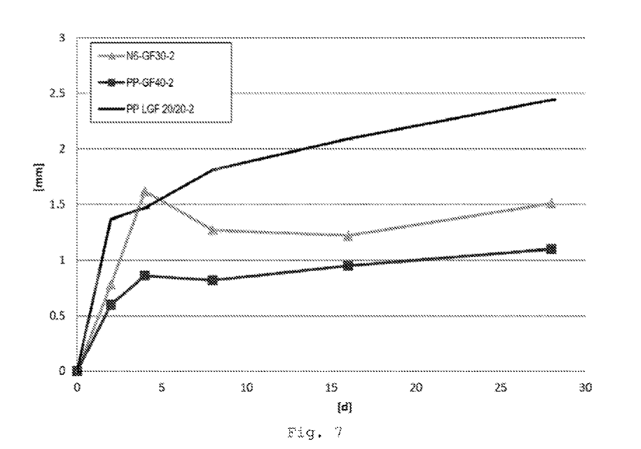

FIG. 6 tensile tests according to DIN EN ISO 527-2 at 8 N/mm²;

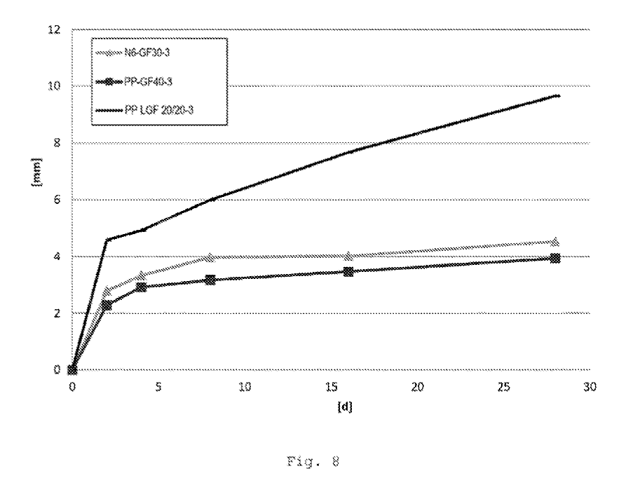

FIG. 7 tensile tests according to DIN EN ISO 527-2 at 8 N/mm²;

FIG. 8 tensile tests according to DIN EN ISO 527-2 at 20 N/mm².

### EXAMPLES

Experiments were conducted with pure and mixed samples of rice hull ash with different silicon dioxide contents. The particle size distributions of the individual samples I to V are listed in tables 5 and 6. Particle size distributions of the samples are shown in FIGS. 1 (I), 2 (II), 3 (III) and 4 (IVa). The figures show the size in μm (size (microns)) against the proportion that has passed through in % (% passing as a bar) and the percentage of the measurements (% channel; line). The values were determined by means of laser diffraction. The filler IV was additionally analyzed as IVb and IVc with another instrument (ANALYSETTE 22 NanoTec plus, laser diffraction). The filler V was also analyzed twice with the aforementioned instrument. The values in the table indicate the sizes below which there are X % of the particles analyzed; for example 90% 45.56 μm means that a size of less than 45.56 μm was determined for 90% of the particles analyzed.

The exact size distributions are listed in tables 7, 8 and 9.

Fillers of the invention were incorporated into polypropylene in different proportions by weight. The properties of the samples are shown in tables 1 and 2. “A” refers here to samples in which constituents >60 μm were removed by a sieving process, whereas “B” shows the properties of samples with unsieved filler. Comparative samples with 20% by weight of talc as filler show a higher density of 1.11 g/cm³. Comparative samples with 30% by weight of talc as filler show a higher density of 1.15 g/cm³. Comparative samples with 40% by weight of talc as filler show a higher density of 1.26 g/cm³.

The experiments with fillers I to V gave similar results in mixtures as well.

The properties of samples comprising nylon-6,6 (N 66) are shown in tables 3 and 4. “A” refers here to samples in which constituents >60 μm were removed by a sieving process, whereas “B” shows the properties of samples with unsieved filler. Comparative samples with 30% by weight of wollastonite as filler show a density of 1.36 g/cm³, and those with 40% by weight of wollastonite a density of 1.48 g/cm³. The sieving-out leads to a distinct improvement in the properties.

The bending test was conducted according to DIN EN ISO 178 (ISO standard specimens (80×10×4 in mm); Sample preparation: storage at 23° C. in a closed vessel for equilibration for 16 to 24 hours; test instrument: Instron 4466; test speed: 2 ram/min; span: 64 mm; test temperature: 23° C.; number of samples: 2-3).

The Charpy impact resistance was measured according to DIN EN ISO 179/1 (test instrument: pendulum impact tester with exchangeable pendulums (from Zwick); specimens: ISO standard specimens (80×10×5 mm³); sample preparation: storage at 23° C. in a closed vessel for equilibration for 16 to 24 hours; test instrument: 5J pendulum impact tester; test conditions: 1 eU; specimen type 1; e for impact on the narrow side; test temperature: −30° C.; number of samples: 5).

Tensile tests according to DIN EN ISO 527-2 were conducted with tensile specimens according to DIN EN ISO 527-2 as specimens. The specimens were stored at 23° C. in a closed vessel for equilibration for 16 to 24 hours (test instrument: Instron 5900R universal tester; test speed: 1 mm/min and 5 mm/min; test temperature: 80° C.; number of samples: 4).

FIGS. 5 to 8 show tensile tests according to DIN EN ISO 527-2 for various samples. “TD20” here represents PP with 20% by weight of talc. In the case of the other samples, for example, PP 60-40-1 represents a PP content of 60% and a filler content of 40% (each % by weight). Therefore, test specimens with 20% to 60% by weight of filler were tested. None of these showed any disadvantages with respect to talc.

FIGS. 7 and 8 show experiments with test specimens, with one test specimen having 20% by weight of filler and 20% by weight of long glass fibers in PP compared to test specimens comprising N 6 with 30% by weight of long glass fibers and PP with 40% by weight of long glass fibers.

TABLE 1

| | | Tensile | Tensile | Tensile | Tensile |
|---|---|---|---|---|---|
| | Proportion | modulus | modulus | strength | strength |
| | of filler | of A | of B | of A | of B |
| Matrix | [% by wt.] | [GPa] | [GPa] | [MPa] | [MPa] |
| F PP-20 | 20 | 20.7 | 19.3 | 26 | 25 |
| F PP-30 | 30 | 23.7 | 22.3 | 25 | 25 |
| F PP-40 | 40 | 29.6 | 28.5 | 24 | 23 |
| F PP-50 | 50 | 36.2 | 35.4 | 24 | 23 |
| F PP-60 | 60 | 48.4 | 47.7 | 24 | 22 |

TABLE 2

| | | | Unnotched | Unnotched | |
|---|---|---|---|---|---|
| | | | Charpy | Charpy | |
| | Elongation | Elongation | impact | impact | |
| | at break | at break | resistance | resistance | |
| | of A | of B | of A | of B | Density |
| Matrix | [%] | [%] | [kJ/m²] | [kJ/m²] | [g/cm³] |
| F PP-20 | 6.1 | 5.2 | 15 | 16 | 1.01 |
| F PP-30 | 3.6 | 3.2 | 8 | 9 | 1.06 |
| F PP-40 | 1.8 | 1.5 | 6 | 7 | 1.14 |
| F PP-50 | 1.2 | 1.0 | 4 | 5 | 1.24 |
| F PP-60 | 0.8 | 0.6 | 3 | 4 | 1.36 |

TABLE 3

| | | Tensile | Tensile | Tensile | Tensile |
|---|---|---|---|---|---|
| | Proportion | modulus | modulus | strength | strength |
| | of filler | of A | of B | of A | of B |
| Matrix | [% by wt.] | [GPa] | [GPa] | [MPa] | [MPa] |
| F N 66 - 20 | 20 | 4.4 | 4.2 | 36 | 34 |
| F N 66 - 30 | 30 | 5.1 | 4.5 | 35 | 34 |
| F N 66 - 40 | 40 | 5.8 | 5.2 | 37 | 36 |
| F N 66 - 50 | 50 | 7.1 | 6.5 | 40 | 38 |
| F N 66 - 65 | 65 | 10.1 | 9.2 | 43 | 41 |
| N 66 | — | 1.4 | — | 35 | — |
| N GF | 30 GF | 5.6 | — | 130 | — |

TABLE 4

| | | | Unnotched | Unnotched | |
|---|---|---|---|---|---|
| | | | Charpy | Charpy | |
| | Elongation | Elongation | impact | impact | |
| | at break | at break | resistance | resistance | |
| | of A | of B | of A | of B | Density |
| Matrix | [%] | [%] | [kJ/m²] | [kJ/m²] | [g/cm³] |
| F N 66 - 20 | 0.9 | 0.8 | 38 | 40 | 1.22 |
| F N 66 - 30 | 0.8 | 0.7 | 47 | 50 | 1.28 |
| F N 66 - 40 | 0.7 | 0.65 | 48 | 51 | 1.35 |
| F N 66 - 50 | 0.6 | 0.57 | 55 | 59 | 1.45 |
| F N 66 - 65 | 0.5 | 0.43 | 42 | 45 | 1.62 |
| N 66 | 3 | — | — | — | 1.12 |
| N GF | 5 | — | — | — | 1.38 |

TABLE 5

| Sample | |
|---|---|
| I: ACS 851 (85% by weight of SiO₂) | 90% 387.7 μm |
| | 95% 502.1 μm |
| | 50% 217.8 μm |
| | MV 244.3; MN 75.51; |
| | MA 177.5; SD 102.1 |
| II: ACS 901 (90% by weight of SiO₂) | 90% 226.8 μm |
| | 95% 269.6 μm |
| | 50% 125.0 μm |
| | MV 133.0; MN 19.8; |
| | MA 84.05; SD 69.69 |
| III: ACS 931 (93% by weight of SiO₂) | 90% 372.3 μm |
| | 95% 480.5 μm |
| | 50% 196.9 μm |
| | MV 220.2; MN 34.92; |
| | MA 130.2; SD 114.6 |
| IVa: ACS 952 (95% by weight of SiO₂) | 90% 45.29 μm |
| | 95% 56.37 μm |
| | 50% 19.89 μm |
| | MV 23.39; MN 2.097; |
| | MA 10.52; SD 15.94 |

TABLE 6

| Sample | |
|---|---|
| IVb: ACS 952 (95% by weight of SiO₂) | 90% 45.56 μm |
| | 50% 18.11 μm |
| | 10% 2.86 μm |
| IVc: ACS 952 (95% by weight of SiO₂) | 90% 45.24 μm |
| | 50% 18.25 μm |
| | 10% 2.82 μm |
| Va: ACS 951 (95% by weight of SiO₂) | 90% 36.87 μm |
| | 50% 17.42 μm |
| | 10% 2.38 μm |
| Vb: ACS 951 (95% by weight of SiO₂) | 90% 36.71 μm |
| | 50% 16.99 μm |
| | 10% 2.22 μm |

TABLE 7

| | I | II | III | IVa |
|---|---|---|---|---|
| % Tile | [μm] | [μm] | [μm] | [μm] |
| 10 | 104.7 | 45.04 | 62.73 | 4.65 |
| 20 | 142.6 | 68.18 | 107.1 | 7.95 |
| 30 | 170.6 | 89.35 | 143.1 | 11.56 |
| 40 | 194.6 | 108.0 | 171.3 | 15.59 |
| 50 | 217.8 | 125.0 | 196.9 | 19.89 |
| 60 | 242.3 | 142.1 | 223.5 | 24.34 |
| 70 | 271.0 | 161.3 | 254.2 | 29.25 |
| 80 | 310.4 | 185.9 | 295.1 | 35.32 |
| 90 | 387.7 | 226.8 | 372.3 | 45.29 |
| 95 | 502.1 | 269.6 | 480.5 | 56.37 |

TABLE 8

| Size | I | II | III | IVa |
|---|---|---|---|---|
| [μm] | % pass | % pass | % pass | % pass |
| 1408 | 100.0 | 100.0 | 100.0 | 100.0 |
| 1184 | 99.75 | 100.0 | 99.77 | 100.0 |
| 995.6 | 99.48 | 100.0 | 99.53 | 100.0 |
| 837.2 | 98.79 | 100.0 | 98.90 | 100.0 |
| 704.0 | 97.84 | 100.0 | 98.05 | 100.0 |
| 592.0 | 96.64 | 100.0 | 96.98 | 100.0 |
| 497.8 | 94.9 | 100.0 | 95.42 | 100.0 |
| 418.6 | 92.01 | 99.51 | 92.86 | 100.0 |
| 352.0 | 86.59 | 98.56 | 88.21 | 100.0 |
| 296.0 | 76.88 | 96.68 | 80.19 | 100.0 |
| 248.9 | 62.51 | 93.06 | 68.49 | 100.0 |
| 209.3 | 46.34 | 86.60 | 54.79 | 100.0 |
| 176.0 | 32.12 | 76.44 | 41.78 | 100.0 |
| 148.0 | 21.74 | 63.24 | 31.58 | 100.0 |
| 124.5 | 14.74 | 49.70 | 24.41 | 99.90 |
| 104.7 | 10.01 | 38.12 | 19.43 | 99.48 |
| 88.00 | 6.73 | 29.32 | 15.71 | 98.88 |
| 74.00 | 4.44 | 22.65 | 12.62 | 97.95 |
| 62.23 | 2.88 | 17.34 | 9.88 | 96.38 |
| 52.33 | 1.83 | 13.01 | 7.44 | 93.66 |
| 44.00 | 1.12 | 9.59 | 5.37 | 89.11 |
| 37.00 | 0.61 | 7.04 | 3.73 | 82.24 |
| 31.11 | 0.22 | 5.20 | 2.49 | 73.38 |
| 26.16 | 0.00 | 3.86 | 1.57 | 63.90 |
| 22.00 | 0.00 | 2.85 | 0.89 | 54.79 |
| 18.50 | 0.00 | 2.06 | 0.38 | 46.80 |
| 15.56 | 0.00 | 1.42 | 0.00 | 39.92 |

TABLE 9

| Size | I | II | III | IVa |
|---|---|---|---|---|
| [μm] | % pass | % pass | % pass | % pass |
| 13.08 | 0.00 | 0.90 | 0.00 | 33.90 |
| 11.00 | 0.00 | 0.47 | 0.00 | 28.54 |
| 9.25 | 0.00 | 0.11 | 0.00 | 23.74 |
| 7.78 | 0.00 | 0.00 | 0.00 | 19.48 |
| 6.54 | 0.00 | 0.00 | 0.00 | 15.77 |
| 5.50 | 0.00 | 0.00 | 0.00 | 12.59 |
| 4.62 | 0.00 | 0.00 | 0.00 | 9.91 |
| 3.89 | 0.00 | 0.00 | 0.00 | 7.67 |
| 3.27 | 0.00 | 0.00 | 0.00 | 5.81 |
| 2.750 | 0.00 | 0.00 | 0.00 | 4.28 |
| 2.312 | 0.00 | 0.00 | 0.00 | 3.04 |
| 1.945 | 0.00 | 0.00 | 0.00 | 2.07 |
| 1.635 | 0.00 | 0.00 | 0.00 | 1.32 |
| 1.375 | 0.00 | 0.00 | 0.00 | 0.75 |
| 1.156 | 0.00 | 0.00 | 0.00 | 0.32 |
| 0.972 | 0.00 | 0.00 | 0.00 | 0.00 |

1. A plastics compound having a biological component, comprising at least (a) at least one biomineral filler and (b) at least one polymer,
wherein the proportion of biomineral filler is 15% to 90% by weight and the at least one polymer is a thermoplastic or crosslinkable polymer or thermoset.

2. The composition as claimed in claim 1, wherein the biomineral filler material is obtained from a renewable raw material.

3. The plastics compound as claimed in claim 1, wherein the biomineral filler has a silicon dioxide content of at least 80% by weight.

4. The plastics compound as claimed in claim 1, wherein the biomineral filler comprises ash from rice hulls and/or rice husks.

5. The plastics compound as claimed in claim 1, wherein the at least one polymer is selected from the group consisting of polyolefins, polyolefin copolymers, cycloolefin copolymers, polytetrafluoroethylene (PTFE), ethylene/tetrafluoro-ethylene copolymers (ETFE), polyvinylidene difluoride (PVDF), polyvinyl chloride (PVC), polyvinylidene chloride, polyvinyl alcohols, polyvinyl esters, vinyl ester copolymers, polyvinyl alkanals, polyvinyl ketals, polyamides, polyimides, polystyrenes, polycarbonate, polycarbonate copolymers and physical blends of polycarbonates with acrylic-butadiene-styrene copolymers, acrylonitrile-styrene-acrylic ester copolymers, polymethylmethacrylates, polybutyl-acrylates, polybutylmethacrylates, polybutylene terephthalates and polyethylene terephthalates, polyesters such as polyethylene terephthalate (PET), polybutylene terephthalate (PBT) and polyethylene naphthalate (PEN), copolymers, transesterification products and physical mixtures (blends) of the aforementioned polyalkylene terephthalates, poly(meth)-acrylates, polyacrylamides, polyacrylonitrile, poly(meth)acrylate/polyvinylidene difluoride blends, polyurethanes, polystyrene, styrene copolymers such as styrene/butadiene copolymers, styrene/acrylonitrile copolymers (SAN), acrylic ester-styrene acrylonitrile (ASA), alpha-methyl-styrene-acrylonitrile copolymer (AMSAN), styrene-butadiene-styrene (SBS), styrene/ethyl methacrylate copolymers, styrene/butadiene/ethyl acrylate copolymers, styrene/acrylonitrile/methacrylate copolymers, acrylonitrile/butadiene/styrene copolymers (ABS) and methacrylate/butadiene/styrene copolymers (MBS), polyethers, polyether ketones, vinyl ester copolymers, polysulfones, polyethylene terephthalate or polybutylene terephthalates, polyether sulfones, polyether imides, polyphenylene oxide, polyphenylene sulfide, polyglycols, polyaryls, silicones, low-density polyethylene (LDPE), high-density polyethylene (HDPE), ionomers, thermoplastic and thermoset polyurethanes and mixtures thereof.

6. The plastics compound as claimed in claim 1, wherein the polymer is polyethylene, polypropylene, or copolymers thereof.

7. The plastics compound as claimed in claim 1, further comprising compatibilizers or couplers.

8. The plastics compound as claimed in claim 7, wherein the couplers are selected from compounds based on maleic anhydride, maleated polyethylenes or maleated polypropylenes, or copolymers of ethylene or propylene and acrylic acid, methacrylic acid or trimellitic acid.

9. The plastics compound as claimed in claim 1, wherein the biomineral filler has a specific density of up to 2.5 g/cm³.

10. The plastics compound as claimed in claim 1, wherein at least 90% of the particles of the filler have a particle size below 400 μm measured by laser diffraction.

11. The plastics compound as claimed in claim 1, further comprising (c) at least one compatibility-promoting additive.

12. The plastics compound as claimed in claim 1, wherein the compound is in the form of pellets.

13. A process for producing a plastics compound having a biological component as claimed in claim 1, wherein at least (a) at least one biomineral filler and (b) at least one polymer are processed to give a compound.

14. The process as claimed in claim 13, wherein the compounding is effected in a mixing apparatus with high shear forces.

15. A shaped body produced using a compound as claimed in claim 1.

16. A masterbatch comprising a compound as claimed in claim 1, having a content of at least 50% by weight of biological filler.

17. The masterbatch as claimed in claim 16, wherein the biomineral filler has a silicon dioxide content of at least 80% by weight.
